(19) United States
(12) Patent Application Publication
(10) Pub. No.: US 2022/0004970 A1
(43) Pub. Date: Jan. 6, 2022

(54) METHOD, APPARATUS, AND COMPUTER PROGRAM OF AUTOMATICALLY GRANTING INSPECTION AUTHORITY TO WORKER ON BASIS OF WORK RESULTS OF CROWDSOURCING-BASED PROJECT

(71) Applicant: CROWDWORKS INC., Seoul (KR)

(72) Inventors: Min Woo PARK, Gyeonggi-do (KR); Jun Ho LEE, Seoul (KR)

(21) Appl. No.: 17/389,338

(22) Filed: Jul. 30, 2021

Related U.S. Application Data
(63) Continuation of application No. PCT/KR2021/007981, filed on Jun. 24, 2021.

(30) Foreign Application Priority Data
Jul. 3, 2020 (KR) 10-2020-0081925

(51) Int. Cl. G06Q 10/06

(52) U.S. Cl. CPC G06Q 10/06398; G06Q 10/063112; G06Q 10/0633

(57) ABSTRACT

Provided is a method of automatically granting inspection authority to a worker on the basis of work results of a crowdsourcing-based project.

According to the disclosure described above, a worker who has the number of cases of consecutive inspection passes matching a preset first value is extracted, selected as a limited inspector, and automatically granted inspection authority. Therefore, a manager of a project may reduce time and manpower consumed to continuously monitor inspection results for work results of a worker who participates in the project and select a worker having an outstanding work ability.

### TECHNICAL FIELD

One or more embodiments relate to a method, an apparatus, and a computer program of automatically granting inspection authority to a worker on the basis of work results of a crowdsourcing-based project.

### BACKGROUND ART

Recently, more and more companies have been collecting and processing large amounts of data based on crowdsourcing that engages the general public in some processes of company activities. In other words, a company opens one project and allows the general public, i.e., workers, to participate in the corresponding project to collect needed information via the results of work completed by the workers.

Here, the company assigns an inspector the results of work completed by a worker and requests the inspector to perform inspection work, to collect more reliable information.

In detail, when one project is opened, a plurality of tasks are assigned to each of a plurality of workers. Each worker performs a plurality of assigned tasks and provides work results of the tasks. Each of a plurality of inspectors is assigned a plurality of inspection works for the work results, and each inspector performs the plurality of inspection works that are assigned.

An outstanding worker from among workers participating in a project is sometimes selected as an inspector of the corresponding project. For example, in progress of the project, when an additional inspector is needed due to the occurrence of a bottleneck in inspection performance or the deviation of an existing inspector, an outstanding worker having a high understanding of the project may be selected as an inspector and put into the project quickly. However, in this method, a manager of the project may separately evaluate a worker's work performance ability and select an outstanding worker, thereby additionally consuming time and workers.

In addition, as the outstanding worker is selected as an inspector, a company that commissions the project loses the outstanding worker. Accordingly, the overall work schedule of the project may be disrupted, and the quality of work results may be deteriorated.

Therefore, there is a need for a method of automatically selecting an outstanding worker as an inspector without the intervention of a manager of a project, and preventing, in this process, the loss of the outstanding worker.

### DESCRIPTION OF EMBODIMENTS

### Technical Problem

One or more embodiments include a method of automatically granting inspection authority to a worker on the basis of work results of a crowdsourcing-based project.

The problems to be solved by the disclosure are not limited to the problems described above, and other problems may be present.

### Solution to Problem

According to one or more embodiments, a method of automatically granting inspection authority to a worker on the basis of work results of a crowdsourcing-based project (hereinafter referred to as a project), performed by a computer, includes: assigning a plurality of tasks of the project to a plurality of workers and requesting to perform the tasks; receiving a plurality of work results from the plurality of workers; assigning the plurality of work results to a plurality of inspectors and requesting to perform inspection; receiving, from the plurality of inspectors, a plurality of inspection results for the plurality of work results as inspection passes or rejections; calculating a number of cases of consecutive inspection passes by counting the number of cases of inspection passes for each worker, on the basis of the inspection results; extracting a worker having the number of cases of consecutive inspection passes matching a preset first value and selecting the extracted worker as a limited inspector; and granting the limited inspector inspection authority to perform the tasks of the project and perform the inspection at the same time, wherein the plurality of inspectors include the limited inspector, the assigning the plurality of work results to the plurality of inspectors and requesting to perform the inspection includes assigning the limited inspector work results of tasks corresponding to the number of inspectable tasks and requesting to perform inspection, and the granting the limited inspector the inspection authority to perform the tasks of the project and perform the inspection at the same time includes: calculating the number of inspectable tasks by counting the number of cases of inspection passes of the limited inspector, on the basis of inspection results for work results of the limited inspector; and granting the limited inspector inspection authority over work results of tasks corresponding to the number of inspectable tasks, and the number of inspectable tasks increases according to a number of cases of inspection passes from among work results that are input by the limited inspector while performing the tasks of the project at the same time, after being selected as the limited inspector.

The method may further include depriving the limited inspector of the inspection authority to perform the tasks of the project and perform the inspection at the same time, and canceling selection as the limited inspector of the project, wherein the canceling the selection as the limited inspector includes: counting the number of rejected cases of the limited inspector, on the basis of inspection results for work results of the limited inspector; and depriving the inspection authority to perform the tasks of the project and perform the inspection at the same time, and canceling the selection as the limited inspector of the project, on the basis of the number of rejected cases of the limited inspector.

The depriving the inspection authority and canceling the selection as the limited inspector may include maintaining the inspection authority of the limited inspector only for work results of tasks corresponding to the number of inspectable tasks calculated up to the present, and then depriving the inspection authority.

The counting the number of rejected cases of the limited inspector may include counting the number of rejected cases of the limited inspector after being selected as the limited inspector.

The selecting as the limited inspector may include, when the number of cases of consecutive inspection passes of the worker who is canceled from the selection as the limited inspector matches a preset first value, re-extracting the worker canceled from the selection and re-selecting the re-extracted worker as a limited inspector.

The assigning the plurality of work results to the plurality of inspectors and requesting to perform the inspection may include assigning the limited inspector work results received from another worker except for work results received from the limited inspector and requesting to perform inspection.

The method may further include, when the inspection results are received as rejections, requesting a worker who performs work on rejected work results to perform rework, wherein the work results include rework results that are the results of rework performed by the worker, and the calculating the number of cases of consecutive inspection passes includes calculating the number of cases of consecutive inspection passes by counting the number of cases of inspection passes for each worker, on the basis of the inspection results including inspection results for the rework results.

The calculating the number of cases of consecutive inspection passes may include calculating the number of cases of consecutive inspection passes by counting the number of cases of initial inspection passes for each worker, on the basis of the inspection results.

An inspector (hereinafter referred to as an unlimited inspector) other than the limited inspector from among the plurality of inspectors may be granted inspection authority that is not limited on the number of cases, and the limited inspector may be granted inspection authority over work results of tasks corresponding to the number of inspectable tasks.

According to one or more embodiments, a computer program may be combined with a computer that is hardware to execute the method of automatically granting an inspection authority to a worker on the basis of work results of a crowdsourcing-based project, and may be stored in a computer-readable recording medium.

According to one or more embodiments, an apparatus for automatically granting inspection authority to a worker on the basis of work results of a crowdsourcing-based project includes: a memory storing a program for automatically granting inspection authority to the worker; and a processor controlling an operation associated with the automatically grating the inspection authority, wherein when the program is executed, the processor performs: assigning a plurality of tasks of the project to a plurality of workers and requesting to perform the tasks; receiving a plurality of work results from the plurality of workers; assigning the plurality of work results to a plurality of inspectors and requesting to perform inspection; receiving, from the plurality of inspectors, a plurality of inspection results for the plurality of work results as inspection passes or rejections; calculating a number of cases of consecutive inspection passes by counting a number of cases of inspection passes for each worker, on the basis of the inspection results; extracting a worker having the number of cases of consecutive inspection passes matching a preset first value and selecting the extracted worker as a limited inspector; and granting the limited inspector inspection authority to perform the tasks of the project and perform the inspection at the same time, wherein the plurality of inspectors include the limited inspector, the assigning the plurality of work results to the plurality of inspectors and requesting to perform the inspection includes assigning the limited inspector work results of tasks corresponding to a number of inspectable tasks and requesting to perform inspection, the granting the limited inspector the inspection authority to perform the tasks of the project and perform the inspection at the same time includes: calculating the number of inspectable tasks by counting the number of cases of inspection passes of the limited inspector, on the basis of inspection results for work results of the limited inspector; and granting the limited inspector inspection authority over work results of tasks corresponding to the number of inspectable tasks, an inspector (hereinafter, an unlimited inspector) other than the limited inspector from among the plurality of inspectors is granted inspection authority that is not limited on the number of cases, the limited inspector is granted inspection authority over work results of tasks corresponding to the number of inspectable tasks, and the number of inspectable tasks increases according to a number of cases of inspection passes from among work results that are input by the limited inspector while performing the tasks of the project at the same time, after being selected as the limited inspector.

According to one or more embodiments, a computer program stored in a computer-readable recording medium to be combined with a computer to execute a method of automatically granting inspection authority to a worker on the basis of work results of a crowdsourcing-based project performs: assigning a plurality of tasks of the project to a plurality of workers and requesting to perform the tasks; receiving a plurality of work results from the plurality of workers; assigning the plurality of work results to a plurality of inspectors and requesting to perform inspection; receiving, from the plurality of inspectors, a plurality of inspection results for the plurality of work results as inspection passes or rejections; calculating a number of cases of consecutive inspection passes by counting a number of cases of inspection passes for each worker, on the basis of the inspection results; extracting a worker having the number of cases of consecutive inspection passes matching a preset first value and selecting the extracted worker as a limited inspector; and granting the limited inspector inspection authority to perform the tasks of the project and perform the inspection at the same time, wherein the plurality of inspectors include the limited inspector, the assigning the plurality of work results to the plurality of inspectors and requesting to perform the inspection includes assigning the limited inspector work results of tasks corresponding to a number of inspectable tasks and requesting to perform inspection, the granting the limited inspector the inspection authority to perform the tasks of the project and perform the inspection at the same time includes: calculating the number of inspectable tasks by counting the number of cases of inspection passes of the limited inspector, on the basis of inspection results for work results of the limited inspector; and granting the limited inspector inspection authority over work results of tasks corresponding to the number of inspectable tasks, an inspector (hereinafter, an unlimited inspector) other than the limited inspector from among the plurality of inspectors is granted inspection authority that is not limited on the number of cases, the limited inspector is granted inspection authority over work results of tasks corresponding to the number of inspectable tasks, and the number of inspectable tasks increases according to a number of cases of inspection passes from among work results that are input by the limited inspector while performing the tasks of the project at the same time, after being selected as the limited inspector.

Other detailed matters of the disclosure are included in the description and drawings.

### Advantageous Effects of Disclosure

According to the disclosure described above, a worker who has the number of cases of consecutive inspection passes matching a preset first value is extracted, selected as a limited inspector, and automatically granted inspection authority. Therefore, a manager of a project may reduce time and manpower consumed to continuously monitor inspection results for work results of a worker who participates in the project and select a worker having an outstanding work ability.

Also, a limited inspector may continue to perform tasks as a worker of the project even after being granted inspection authority. Accordingly, the loss of workers occurring in a process of selecting a worker having an outstanding work performance ability as a limited inspector may be prevented.

Also, whether or not to deprive the limited inspector of the inspection authority may be determined on the basis of inspection results for work results that are input as a worker by the limited inspector. Therefore, the limited inspector may continue to perform tasks of the project, and first of all, the quality of work results may be improved by inducing the limited inspector to precisely perform tasks.

Effects of the disclosure are not limited to the effects mentioned above, and other unmentioned effects will be clearly understood by those skilled in the art from the following description.

### BRIEF DESCRIPTION OF THE DRAWINGS

FIG. 1 is a conceptual diagram of a crowdsourcing service according to an embodiment.

FIG. 2 is a flowchart illustrating a process of a crowdsourcing-based project, according to an embodiment.

FIG. 3 is a conceptual diagram illustrating a normal method of selecting an inspector of a project.

FIG. 4 is a conceptual diagram illustrating a method of automatically granting inspection authority to a worker on the basis of work results, according to an embodiment.

FIG. 5 is a flowchart schematically illustrating a method of automatically granting inspection authority to a worker on the basis of work results of a crowdsourcing-based project, according to an embodiment.

FIG. 6 is an example view illustrating a method of calculating the number of cases of consecutive inspection passes by counting the number of cases of inspection passes, according to an embodiment.

FIG. 7 is a flowchart schematically illustrating a method of granting inspection authority to a limited worker, according to an embodiment.

FIG. 8 is an example view illustrating a method of calculating the number of inspectable tasks on the basis of the number of cases of inspection passes of a limited inspector, and granting inspection authority over work results corresponding to the calculated number of inspectable tasks, according to an embodiment.

FIG. 9 is an example view illustrating a method of calculating the number of cases of consecutive inspection passes of a worker by counting the number of cases of inspection passes including inspection results for rework results, according to an embodiment.

FIG. 10 is an example view illustrating a method of calculating the number of cases of consecutive inspection passes of a worker by counting the number of cases of inspection passes on the basis of work results that have first passed inspection, according to another embodiment.

FIG. 11 is a flowchart schematically illustrating an operation of depriving a limited inspector of inspection authority and canceling selection as the limited inspector, according to an embodiment.

FIG. 12 is a flowchart schematically illustrating a method of depriving a limited inspector of inspection authority and canceling selection as the limited inspector, according to an embodiment.

FIG. 13 is an example view illustrating that inspection authority of a limited inspector is maintained only for work results of tasks corresponding to the number of inspectable tasks calculated up to the present, and then deprived, according to an embodiment.

FIG. 14 is an example view illustrating that the number of rejected cases is counted on the basis of inspection results for work results of a limited inspector that are input after being selected as the limited inspector, according to an embodiment.

FIG. 15 is a diagram illustrating an apparatus for automatically granting inspection authority to a worker on the basis of work results of a crowdsourcing-based project, according to an embodiment.

### MODE OF DISCLOSURE

Advantages and features of the disclosure, and methods of achieving thereof will become apparent with reference to the embodiments described below in detail in conjunction with the accompanying drawings. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art, and the disclosure is merely defined by the scope of claims.

The terminology used herein is for the purpose of describing the embodiments and is not intended to limit the disclosure. As used herein, the singular forms are intended to include the plural forms as well, unless the context clearly indicates otherwise. The terms “comprises” and/or “comprising” when used in this specification do not preclude the presence or addition of one or more other elements in addition to stated elements. Like reference numerals refer to like elements throughout. As used herein, the term “and/or” includes any and all combinations of one or more of the associated listed items. Although the terms “first,” “second,” etc. may be used herein to describe various elements or components, these elements or components should not be limited by these terms. These terms are only used to distinguish one element or component from another element or component. Thus, a first element or component discussed below may be termed a second element or component without departing from the scope of example embodiments.

Unless otherwise defined, all terms (including technical and scientific terms) used herein have the same meanings as commonly understood by one of ordinary skill in the art to which example embodiments belong. Terms, such as those defined in commonly used dictionaries, will not be interpreted in an idealized or overly formal sense unless expressly so defined herein.

Hereinafter, one or more embodiments will be described in detail with reference to the accompanying drawings.

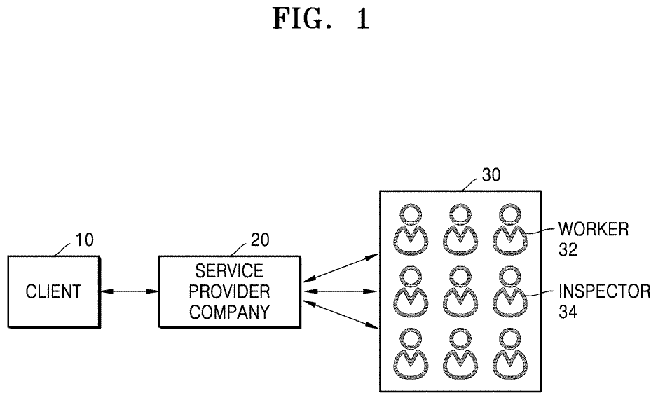

FIG. 1 is a conceptual diagram of a crowdsourcing service according to an embodiment.

Referring to FIG. 1, a crowdsourcing service is performed by constituting a client 10, a service provider company 20, and the public 30.

The client 10 refers to a company or individual that commissions a crowdsourcing-based project (hereinafter referred to as a project).

The client 10 commissions the project, for the collection of source data for the generation of artificial intelligence learning data, data annotation, or the like. Data generated via the project may be used as learning data for any machine learning such as supervised learning, unsupervised learning, or reinforcement learning. The collection of the source data refers to the collection of raw data such as the correction of recorded voice and the collection of photos. The data annotation refers to inputting associated annotation data into source data such as text, photos, and video. For example, the data annotation may include finding an entity in given text, finding a similar sentence, and the like but is not limited thereto. The type of project described above is only an embodiment, and various types of projects may be handled in the disclosure according to the design of a client.

The service provider company 20 refers to a company that provides a crowdsourcing service.

When receiving, from the client 10, a request for a product or service project, the service provider company 20 assigns work on the corresponding project to the public 30 and receives the results of work from the public 30. The service provider company 20 provides the client 10 with final outputs extracted on the basis of the results of work.

Here, the service provider company 20 provides the client 10 and the public 30 with crowdsourcing services via a crowdsourcing platform (hereinafter referred to as a platform). In other words, when the service provider company 20 receives a project request from the client 10, the service provider company 20 opens a project on the platform. When the service provider company 20 receives, from the public 30, the results of work on the opened project, the service provider company 20 may end the corresponding project on the platform, extract final outputs, and provide the extracted final outputs to the client 10.

The public 30 refers to the general public who participates in the project opened on the platform. Here, the public 30 may participate in the project opened on the platform, via an application, website, or the like provided by the service provider company 20.

The public 30 includes a worker 32 and an inspector 34.

The worker 32 determines to participate in a particular project from among a plurality of projects opened on the platform. The worker 32 performs work such as the collection of source data and data annotation, and transmits the same to the platform.

The inspector 34 determines to participate in a particular project from among the plurality of projects opened on the platform. The inspector 34 performs inspection on the results of work performed by the worker 32. The inspector 34 may perform inspection pass processing or rejection processing as the results of the inspection performance, and may input the reasons for the rejections when performing rejection processing. In the cases of inspection passes, reworks and subsequent reinspection are not needed, and thus, inspection passes mean the same as the completion of inspection.

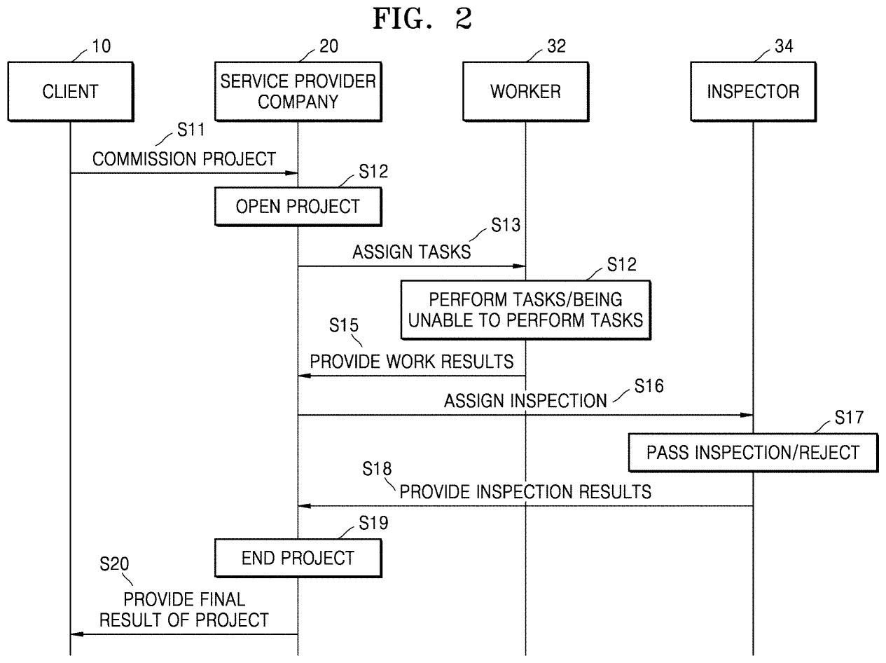

FIG. 2 is a flowchart illustrating a process of a crowdsourcing-based project according to an embodiment.

In operation S11, a client 10 commissions one or more projects to a service provider company 20.

In operation S12, the service provider company 20 opens the commissioned projects on a platform. Here, before opening a project, the service provider company 20 may determine a grade of the project by considering a level of difficulty of the corresponding project and the like. In other words, the service provider company 20 may determine to expose the corresponding project to the public 30 having a certain grade or higher, according to the level of difficulty. Accordingly, the reliability of work results of a project may be improved.

In operation S13, the service provider company 20 assigns tasks to a worker 32 having a corresponding grade or higher, according to the grade of the project, and requests to perform the tasks.

In operation S14, the worker 32 performs the allocated tasks. Here, the worker 32 may not perform a task that may not be performed for some reasons and input a reason for not being able to perform the task.

In operation S15, the service provider company 20 receives work results from the worker 32 and, in operation S16, assigns inspection work for the corresponding work results to an inspector 34 and requests inspection.

In operation S17, the inspector 34 performs the assigned inspection. Here, the inspector 34 determines an inspection pass when a task is determined as being appropriately performed and processes the task as a rejection when the task is determined, via inspection work, as being incorrectly performed. When processing the rejection, the inspector 34 inputs a reason for the rejection of the task being determined as being incorrectly performed.

In operation S18, the service provider company 20 receives the results of inspection from the inspector 34.

When the results of inspection are inspection passes, the service provider company 20 uses the corresponding work results as valid data and, on the basis of the valid data, extracts final outputs at the end of the project.

When the results of inspection are rejection processing, the service provider company 20 may internally re-perform inspection, or may re-assign tasks to the worker 32 and request to perform rework. Reinspection by an inspector is needed upon rework.

The service provider company 20 terminates the corresponding project in operation S19 when a project period ends or sufficient valid data is secured, and, on the basis of the secured valid data, calculates the final results and provides the final results to the client 10 in operation S20.

Here, before the project ends, the service provider company 20 evaluates the performance results of the worker 32 and the inspector 34, calculates work cost and inspection cost according to the evaluation, and pays the work cost and inspection cost to the worker 32 and the inspector 34.

FIGS. 1 and 2 simply illustrate the client 10, the service provider company 20, the worker 32, and the inspector 34. However, the client 10, the service provider company 20, the worker 32, and the inspector 34 may refer to computer apparatuses or telecommunication devices such as smartphones, tablets, personal digital assistants (PDAs), laptops, desktops, and servers operated by respective participants.

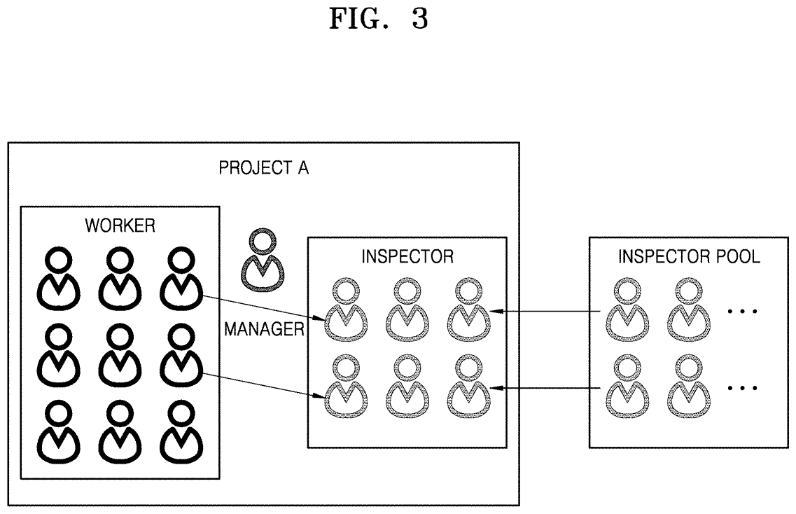

Hereinafter, a method of automatically granting inspection authority to a worker on the basis of work results of a crowdsourcing-based project, according to an embodiment will be described with reference to FIGS. 3 through 15. The same detailed descriptions as those of the configuration of the crowdsourcing service and the process of the crowdsourcing-based project that have been described above with reference to FIGS. 1 and 2 will be omitted herein.

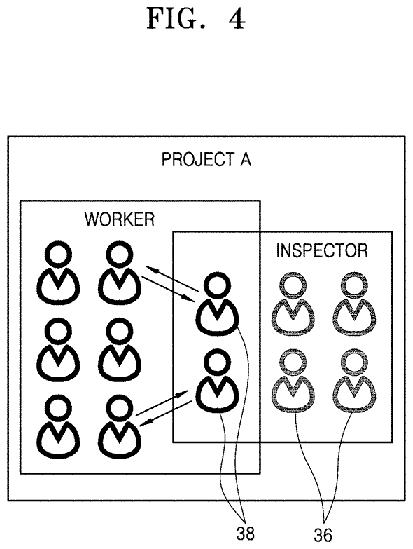

FIG. 3 is a conceptual diagram illustrating a normal method of selecting an inspector of a project. FIG. 4 is a conceptual diagram illustrating a method of automatically granting inspection authority to a worker on the basis of work results of work, according to an embodiment.

Referring to FIG. 3, a normal method of selecting an inspector of a project will now be described. When a project is opened or the project is in progress, an inspector appropriate for the corresponding project is selected from an inspector pool on a crowdsourcing platform and granted inspection authority.

In some embodiments, when the project is in progress, a manager of the corresponding project may extract a worker having an outstanding work performance ability from among workers who participate in the project, select the extracted worker as an inspector, and grant inspection authority to the selected inspector. A method of selecting an outstanding worker as an inspector enables a worker having a high understanding of a project to be selected as an inspector, thereby reducing time and effort needed for pre-training associated with the performance of inspection and quickly putting the inspector into the project.

However, a project manager may continuously monitor inspection results for work results of a plurality of workers, evaluate the work performance ability of each of the workers, and select a worker appropriate as an inspector to extract an outstanding worker from among workers of a project. Accordingly, the time of the project manager, and manpower may be needlessly wasted. In a process of selecting a worker as an inspector, an outstanding worker may be lost as an inspector, thereby degrading the quality of work results of the entire project.

Referring to FIG. 4, according to one or more embodiments, even without the intervention of a manager of a project, a worker having an outstanding work ability may be extracted from among workers who participate in the project, and may be automatically granted inspection authority over the corresponding project. Also, although not clearly shown, whether or not inspection authority of a worker selected as an inspector is maintained may be determined on the basis of work results of the worker, thereby inducing the continuous work performance of the worker selected as the inspector. Hereinafter, one embodiment related to the above description will be described in detail.

As used herein, a limited inspector 38 refers a person who is selected as an inspector due to an outstanding work performance ability from among workers who participate in a project.

Also, an unlimited inspector 36 refers to an inspector excluding a limited inspector from among a plurality of inspectors having inspection authority over the project. In other words, the unlimited inspector 36 refers to an inspector who has inspection authority over the corresponding project and participates in the project, from among a plurality of inspectors included in an inspector pool.

The natures of inspection authority granted to the limited inspector 38 and the unlimited inspector 36 described above are different from each other. The limited inspector 38 is granted inspection authority to perform tasks of the corresponding project and perform inspection at the same time, and the unlimited inspector 36 is granted inspection authority to only perform inspection. The detailed description thereof will follow later.

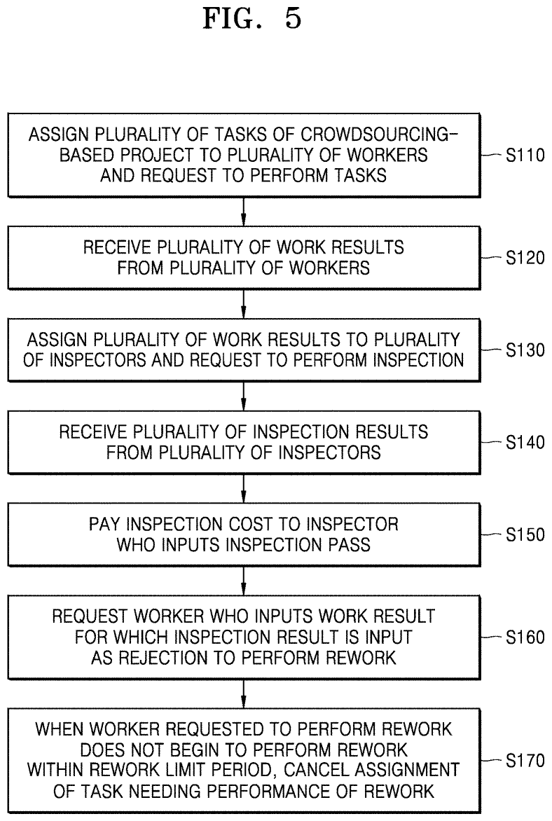

It may be understood that operations illustrated in FIGS. 5, 7, 11, and 12 are performed by a platform server (hereinafter referred to as a server) operated by the service provider company 20, but the operations are not limited thereto.

FIG. 5 is a flowchart schematically illustrating a method of automatically granting inspection authority to a worker on the basis of work results of a crowdsourcing-based project, according to an embodiment.

In operation S110, a plurality of tasks of a project are assigned to a plurality of workers to request to perform the tasks. In operation S120, a plurality of work results are received from the plurality of workers. In operation S130, the plurality of work results are assigned to a plurality of inspectors to request to perform inspection. In operation S140, a plurality of inspection results for the plurality of work results are received as inspection passes or rejections from the plurality of inspectors.

The detailed descriptions of operations S110 through S140 are the same as those given with reference to FIGS. 1 and 2, and thus will be omitted herein.

After the inspection results are received from the inspectors in operation S140, in operation S150, the number of cases of consecutive inspection passes are calculated by counting the number of cases of inspection passes for each worker on the basis of the inspection results.

Here, the number of cases of consecutive inspection passes refers to the number of cases of inspection results that are consecutively input as inspection passes for work results of a worker by one or more inspectors. The number of cases of consecutive inspection passes is calculated for each worker.

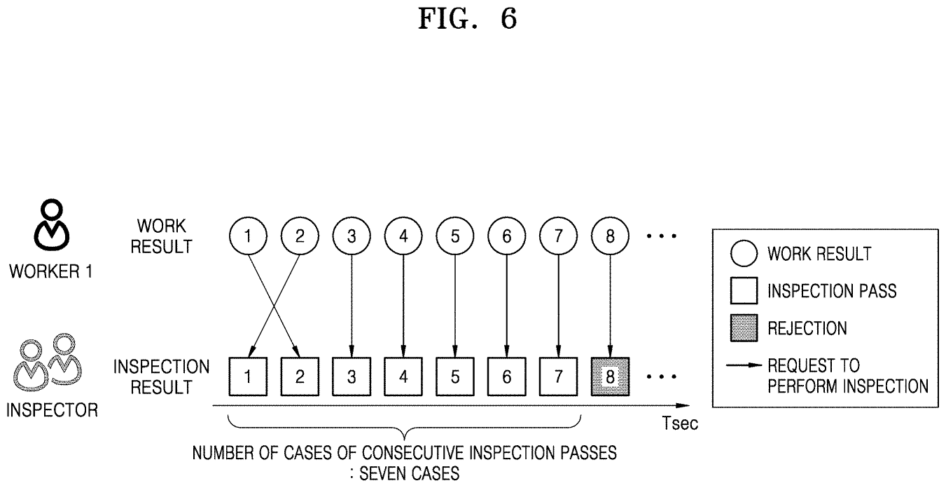

FIG. 6 is an example view illustrating a method of calculating the number of cases of consecutive inspection passes by counting the number of cases of inspection passes, according to an embodiment.

Referring to FIG. 6, inspection is performed on eight work results that are input by a worker 1. The respective work results are assigned to a plurality of inspectors and inspected. Also, each inspector respectively enters inspection results for the assigned work results. Here, a total of seven inspection results are consecutively input as inspection passes before an inspection result for an eighth work result 8 entered by the worker 1 is entered as a rejection. Therefore, the number of cases of consecutive inspection passes of the worker 1 is calculated as seven cases.

An order of inspection results input from an inspector may be different from an order of work results entered by a worker. Referring to FIG. 6, an inspection result for a first work result 1 input by the worker 1 is entered later than an inspector result for a second work result 2 input by the worker 1. This is because inspection performance abilities of respective inspectors or inspection performance start times of the respective inspectors for assigned work results are different. The order of inspection results input from an inspector is not significant, and the number of inspection results that are consecutively entered as inspection passes is significant.

Referring to FIG. 5 again, when the number of cases of inspection passes is calculated for each worker in operation S150, in operation S160, a worker having the number of cases of consecutive inspection passes matching a preset first value is extracted and selected as a limited inspector.

In other words, a worker having the number of cases of consecutive inspection passes matching the first value is selected as a limited inspector, and then granted inspection authority over a corresponding project. Here, the preset first value is a criterion for selecting a limited inspector and refers to a criterion for granting inspection authority. The criterion for granting inspection authority may be set differently according to a level of difficulty or a total workload of each project.

When a worker having an outstanding work performance ability from among workers of a project is selected as a limited inspector, the following effects occur. A worker selected as a limited inspector has a high understanding of a corresponding project, and thus may perform inspection more quickly than the unlimited inspector 36 who is put in while the project is in progress. Also, the limited inspector has an opportunity to re-learn about a right work performance method and improve the work performance method of the limited inspector by repeatedly performing inspection on work results of other workers. As a result, the limited inspector may improve the quality of the results of work performed as a worker of the corresponding project.

Referring to FIG. 5 again, in operation S170, the selected limited inspector is granted inspection authority to perform tasks of the project and perform inspection at the same time.

In detail, the limited inspector may continue to perform tasks even after being granted the inspection authority over the corresponding project. In other words, the limited inspector may perform tasks and perform inspection at the same time. This inspection authority is distinguished from inspection authority of the unlimited inspector 36 who totally performs only inspection.

As described above, limited inspectors include workers having outstanding work performance abilities. When a limited inspector is granted inspection authority to perform only inspection, like the unlimited inspector 36, outstanding workers may be continuously lost in a process of selecting limited inspectors. As a result, the quality of the overall work results of a project may be lowered, and the overall schedule of the project may be delayed. Accordingly, unlike the unlimited inspector 36, a limited inspector is granted inspection authority to perform tasks of a project concurrently with inspection, thereby preventing the loss of outstanding workers.

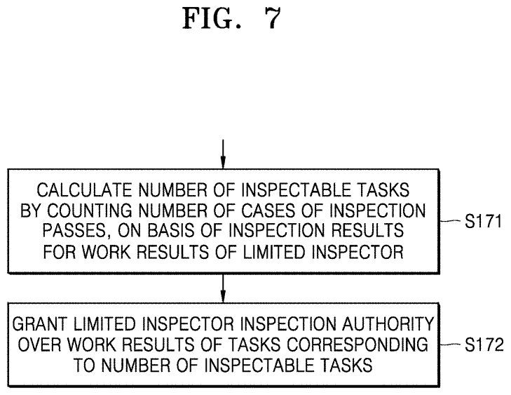

FIG. 7 is a flowchart schematically illustrating a method of granting inspection authority to a limited inspector, according to an embodiment.

Referring to FIG. 7, according to an embodiment, an operation of granting the limited inspector 38 inspection authority to perform tasks of a project and inspection at the same time includes: operation S171 of, on the basis of inspection results for work results of a limited inspector, calculating the number of inspectable tasks by counting the number of cases of inspection passes of the limited inspector; and operation S172 of granting the limited inspector inspection authority over work results of tasks corresponding to the number of inspectable tasks.

Here, the work results of the limited inspector refer to work results that are input after the limited inspector performs tasks of a corresponding project as a worker after being selected as the limited inspector. The number of inspectable tasks refers to the number of work results on which the limited inspector may perform inspection. Unlike the unlimited inspector 36, the limited inspector may not indefinitely maintain inspection authority. The limited inspector is selected on the basis of work results, and thus, whether or not to maintain inspection authority is determined by continuously verifying the quality of the work results.

In detail, the number of inspectable tasks of the limited inspector is calculated by counting the number of work results that pass inspection, from among the work results of the limited inspector. In other words, the number of inspectable tasks of the limited inspector is calculated in connection with work results that are input by the limited inspector as a worker, and inspection authority is granted to the limited inspector.

Accordingly, even after being selected as the limited inspector, the limited inspector may actively perform tasks of corresponding project as a worker. The limited inspector may increase the number of inspectable tasks to maintain inspection authority for a long time. Also, the limited inspector may increase the number of work results that pass inspection, from among work results of the limited inspector and thus, may perform many more tasks as a worker.

Referring to FIG. 5 again, according to an embodiment, a plurality of inspectors include limited inspectors, and, in operation S130, a limited inspector is assigned work results of tasks corresponding to the number of inspectable tasks and requested to perform inspection.

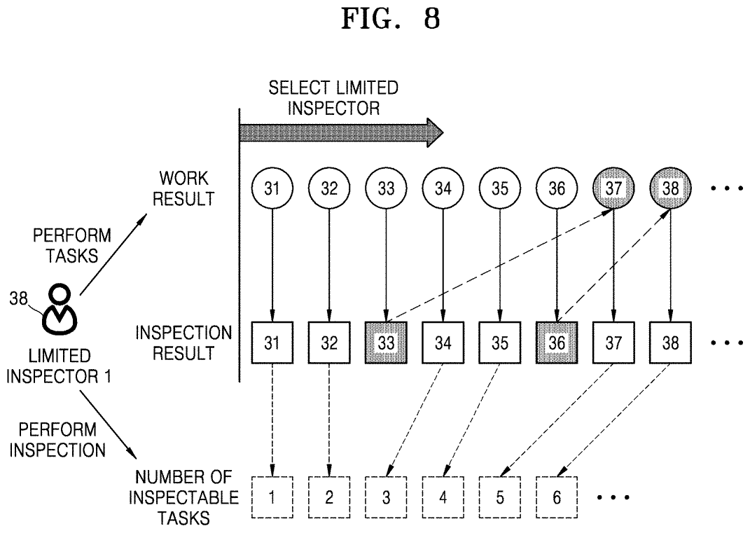

FIG. 8 is an example view illustrating a method of calculating the number of inspectable tasks on the basis of the number of cases of inspection passes of a limited inspector, and granting inspection authority over work results corresponding to the calculated number of inspectable tasks, according to an embodiment.

Referring to FIG. 8, six work results pass inspection, from among work results that are input by a limited inspector 1 after being selected as a limited inspector. Here, whenever inspection results are input as inspection passes, the number of cases of inspection passes of a limited inspector may be counted, and the number of inspectable tasks of the limited inspector 1 may be calculated as six cases. Also, the limited inspector 1 is granted inspection authority over work results corresponding to the six cases.

The limited inspector 1 may sequentially input work results after a task result 38 that is lastly entered by the limited inspector 1. Also, when inspection results for the sequentially input work results are input as inspection passes by an inspector, the number of cases of inspection passes of the limited inspector 1 may be re-counted, and accordingly, the number of inspectable tasks may also be calculated by adding the counted number of cases to the previously calculated six cases. As a result, inspection authority granted to the limited inspector 1 may also be updated to inspection authority over work results of the inspectable tasks of the increased number.

According to an embodiment, an operation of assigning a plurality of work results to a plurality of inspectors and requesting to perform inspection may include assigning a limited inspector work results that are received from other workers except for work results that are received from the limited inspector, and requesting to perform inspection.

In detail, the limited inspector may perform tasks of a corresponding project as a worker and input work results. Here, when the work results input by the limited inspector are assigned to the corresponding limited inspector, the limited inspector performs inspection on the work results of the limited inspector. As a result, the fairness of the performance of inspection may be lowered, and the reliability of inspection results may be lost. Accordingly, the limited inspector is assigned work results received from other workers and requested to perform inspection, to prevent the foregoing drawbacks.

According to an embodiment, from among a plurality of inspectors, an inspector (hereinafter referred to as an unlimited inspector) who is not a limited inspector may be granted inspection authority that is not limited on the number of cases, and a limited inspector may be granted inspection authority over work results of tasks corresponding to the number of inspectable tasks.

Referring to FIG. 4, according to an embodiment, inspectors of a project are divided into limited inspectors and unlimited inspectors 36. The unlimited inspector 36 is selected by extracting, from an inspection pool, an inspector appropriate for the corresponding project and granting inspection authority over the corresponding project. The inspector pool includes merely inspectors having inspection performance abilities that are sufficiently verified via a plurality of other projects. Therefore, an inspection performance ability of the unlimited inspector 36 is superior to an inspection performance ability of a limited inspector. Therefore, unlike a limited inspector, the unlimited inspector 36 is granted inspection authority that is not limited on the number of cases.

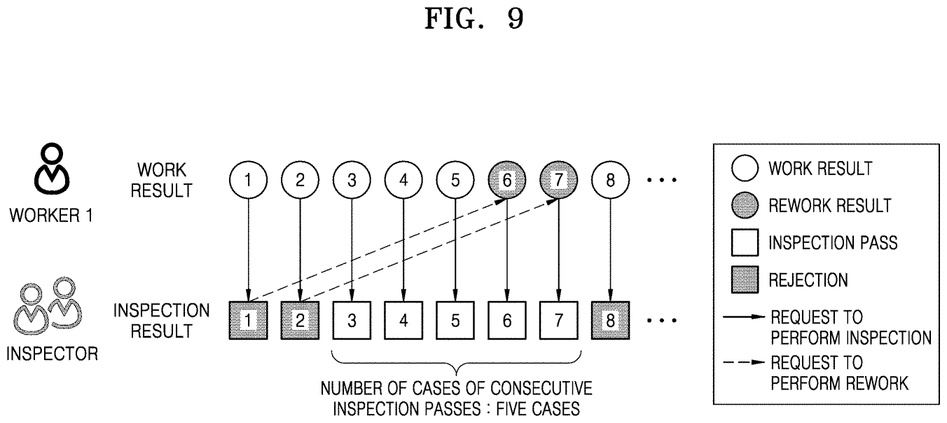

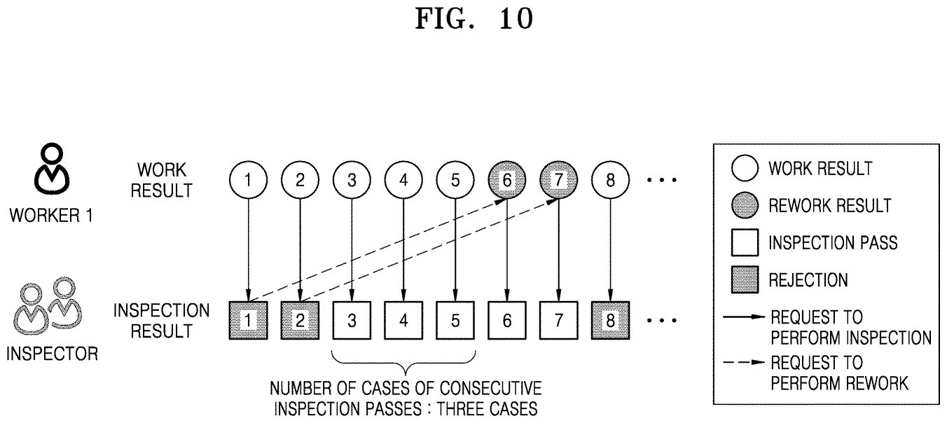

Hereinafter, a detailed method of calculating the number of cases of consecutive inspection passes, according to an embodiment will be described with reference to FIGS. 9 and 10.

FIG. 9 is an example view illustrating a method of calculating the number of cases of consecutive inspection passes of a worker by counting the number of cases of inspection passes including inspection results for rework results, according to an embodiment. FIG. 10 is an example view illustrating a method of calculating the number of cases of consecutive inspection passes of a worker by counting the number of cases of inspection passes on the basis of work results that have first passed inspection.

Although not clearly shown in the drawings, according to an embodiment, an operation of, when an inspection result is received as a rejection, requesting a worker who has performed work on the rejected work result, to perform rework is further included, and the work result includes a rework result that is the result of rework performance of the worker. Here, an operation of calculating the number of cases of consecutive inspection passes may include calculating, on the basis of the inspection result including the inspection result for of the rework result, calculating the number of cases of consecutive inspection passes by counting the number of cases of inspection passes for each worker.

For example, referring to FIG. 9, from among work results input by a worker 1, a work result 1 and a work result 2 are rejected respectively. Also, the worker 1 performs rework on tasks respectively corresponding to the work result 1 and the work result 2, and then inputs a rework result 6 and a rework result 7, respectively. Here, the number of cases of consecutive inspection passes of the worker 1 is calculated by including the rework results. Therefore, the number of cases of consecutive inspection passes of the worker 1 corresponds to five cases (a work result 3 through a work result 7).

In operation S150, on the basis of inspection results, the number of cases of consecutive inspection passes may be calculated by counting the number of cases of initial inspection passes for each worker.

The number of cases of first inspection passes refers to the number of work results having inspection results that are input as inspection passes upon first inspection performance, from among a plurality of work results on which an inspector performs inspection. In other words, the number of cases of first inspection passes refers to the number of work results that pass inspection without being rejected and being requested a worker to perform reinspection.

For example, referring to FIG. 10, a work result 1 and a work result 2 from among work results input from a worker 1 are rejected as a result of initial inspection performance of an inspector. A server requests the worker 1 to perform rework on tasks respectively corresponding to the rejected work result 1 and work result 2. Both a rework result 6 and a rework result 7 that are input after the rework performance of the worker 1 pass inspection as a result of the inspector's inspection. However, although passing the inspection, both the rework result 6 and the rework result 7 do not correspond to inspection results that are entered as initial inspection passes, and thus are not counted to calculate the number of cases of consecutive inspection passes. Therefore, the number of cases of consecutive work passes of the worker 1 is calculated as three cases (the work result 3 through the work result 5).

As described above, the number of cases of consecutive inspection passes may be calculated only for initial inspection passes from among inspection results for work results of a worker, thereby strictly evaluating the work ability of the worker and more carefully selecting a limited inspector. The limited inspector selected as described above has a superior work ability to other workers. Therefore, most of the results of tasks performed after being selected as the limited inspector may also pass inspection. In other words, this indicates that the number of inspectable cases needed to maintain inspection authority of the limited inspector is further increased. Accordingly, a limited inspector selected on the basis of the number of cases of initial inspection passes may maintain inspection authority for a longer time than a limited inspector selected simply on the basis of the number of cases of inspection passes. Therefore, the quality of inspection results may increase by securing an inspector having a high understanding of a project.

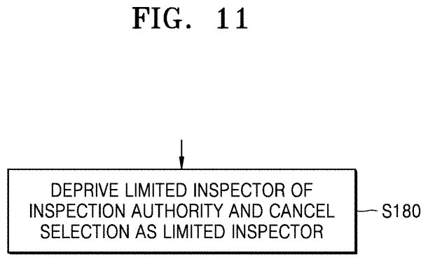

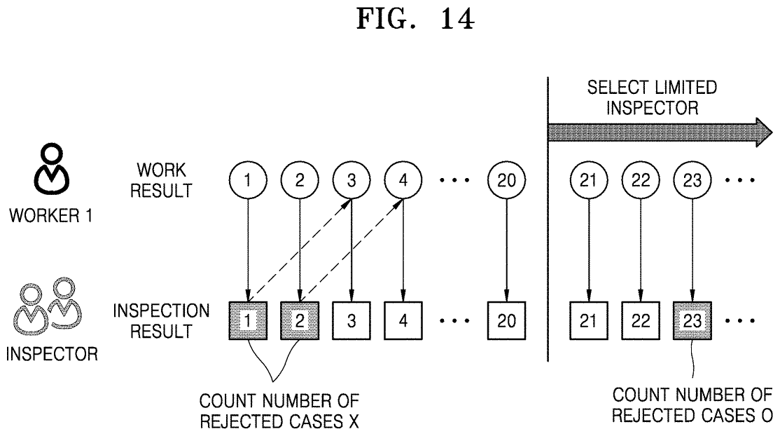

Hereinafter, a method of depriving a limited inspector of inspection authority and canceling selection as the limited inspector will be described in detail with reference to FIGS. 11 and 14.

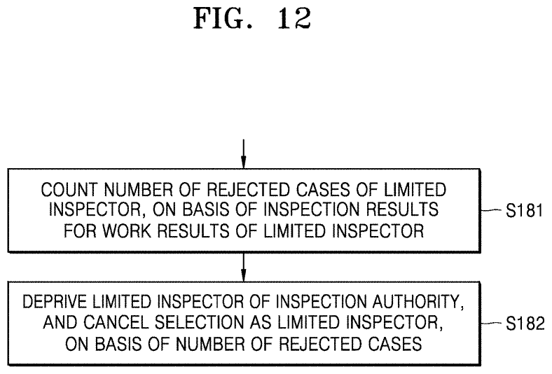

FIG. 11 is a flowchart schematically illustrating an operation of depriving a limited inspector of inspection authority and cancelling selection as the limited inspector, according to an embodiment. FIG. 12 is a flowchart schematically illustrating a method of depriving a limited inspector of inspection authority and cancelling selection as the limited inspector, according to an embodiment.

Referring to FIG. 11, according to an embodiment, the method of automatically granting inspection authority to a worker on the basis of work results, described above, may further include operation S180 of depriving a limited inspector of inspection authority to perform tasks of the project and perform inspection at the same time, and canceling the selection as the limited inspector of the project.

Referring to FIG. 12, operation S180 of cancelling the selection as the limited inspector may include: operation S181 of counting the number of rejected cases of the limited inspector on the basis of inspection results for work results of the limited inspector; and operation S182 of, on the basis of the number of rejected cases of the limited inspector, depriving the limited inspector of the inspection authority to perform tasks of the project and perform inspection at the same time, and cancelling the selection as the limited inspector of the projector.

As described above, the number of inspectable cases associated with inspection authority of a limited inspector is calculated in connection with work results that are input by the limited inspector as a worker. In the same way, whether or not to deprive the limited inspector of the inspection authority may also be determined in connection with the work results that are input by the limited inspector as the worker.

In detail, work results input by the limited inspector after performing tasks may be assigned to another inspector to request to perform inspection, and then inspection results may be received as inputs. Here, when the number of cases of inspection results that are input as rejections from among inspection results input by the other inspector matches a preset second value, inspection authority of the limited inspector is deprived. Therefore, a limited inspector who wants to maintain inspection authority for a long time may precisely perform tasks. As a result, work results of the limited inspector have higher quality than work results of other workers.

In other words, when active work performance of a limited inspector for a project is induced via operation S170, the limited inspector is induced to more precisely perform tasks via operation S180.

Here, the preset second value is a criterion for depriving a limited inspector of inspection authority and refers to a criterion for depriving inspection authority.

According to an embodiment, when a limited inspector is deprived of inspection authority, and selection as the limited inspector is canceled, the inspection authority of the limited inspector may be maintained only for work results of tasks corresponding to the number of inspectable tasks that is calculated up to the present, and then, may be deprived.

In other words, even though the number of rejected cases of the limited inspector corresponds to a preset inspection authority deprivation criterion, the limited inspector may not be immediately deprived of authority. Here, the limited inspector may perform inspection on work results of tasks corresponding to the number of inspectable tasks calculated to a point in time at which the number of rejected cases of the limited inspector falls within the inspection authority deprivation criterion.

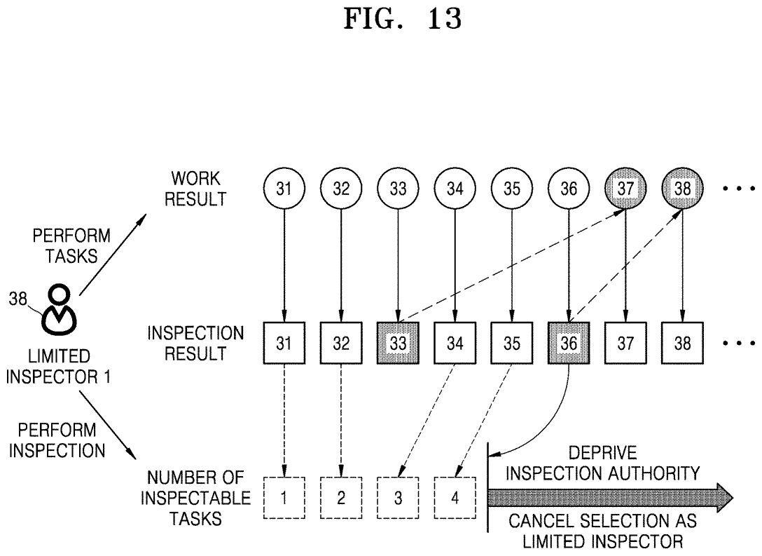

FIG. 13 is an example view illustrating that inspection authority of a limited inspector is maintained only for work results of tasks corresponding to the number of inspectable tasks calculated up to the present, and then deprived, according to an embodiment.

For example, the number of rejected cases for work results of a limited inspector that is an inspection authority deprivation criterion may be two cases. Here, referring to FIG. 13, from among the results of tasks performed by a limited inspector 1 as a worker of a project, a work result 33 and a work result 36 are rejected. Therefore, at a point in time when the work result 36 where two cases that is inspection authority deprivation criterion match the number of rejected cases is rejected, the limited inspector 1 may be deprived of inspection authority. However, four work results of the limited inspector 1 pass inspection before the work result 36 is rejected, and the limited inspector 1 is granted inspection authority over work results corresponding thereto. Therefore, the limited inspector 1 may perform inspection on four work results, and may be deprived of inspection authority after the inspection on the four work results is completed.

Also, according to an embodiment, an operation of counting the number of rejected cases of a limited inspector may include, after being selected as the limited inspector, counting the number of rejected cases of the limited inspector.

FIG. 14 is an example view illustrating that the number of rejected cases is counted on the basis of inspection results for work results of a limited inspector that are input after being selected as the limited inspector, according to an embodiment.

In detail, whether or not to deprive a limited inspector of inspection authority may be determined only on the basis of work results that are input as a worker after being selected as the limited inspector, except for work results that are input before being selected as the limited inspector. Therefore, the fairness may increase in determining whether or not to deprive the limited inspector of the inspection authority.

Referring to FIG. 14, a worker 1 receives rejections of a total of three work results so far. However, a work result 1 and a work result 2 are work results that are input by the worker 1 before being selected as a limited inspector, and thus are not included in the number of rejected cases that is a basis for depriving the limited inspector of authority. Therefore, a work result that is counted from among rejected work results of the worker 1 is a work result 23, and thus, the number of rejected cases of the limited inspector (the worker 1) corresponds to one case.

Also, according to an embodiment, when the number of cases of consecutive inspection passes of a worker who is canceled from selection as a limited inspector matches a preset first value, the worker canceled as the limited inspector may be re-extracted and re-selected as a limited inspector.

In detail, the worker canceled from the selection as the limited inspector may be deprived of only inspection authority over a project, and may participate in the corresponding project. Accordingly, the worker who is canceled from the selection as the limited inspector may participate in the corresponding project, perform tasks, and enter work result. Here, when inspection results for work results are consecutively input as inspection passes by a plurality of inspectors, and the number of cases of consecutive inspection passes matches an inspection authority grant criterion, the worker may be re-extracted and re-selected as a limited inspector.

Here, according to an embodiment, when a limited inspector is re-selected, an inspection authority grant criterion that is a selection criterion for a limited inspector may be applied as a third value less than the first value, rather than the preset first value. A worker who has an experience of being selected as a limited inspector may establish trust in the work performance of the corresponding project. Therefore, unlike other workers, a less reference value may be applied to determine whether or not to select the worker as a limited inspector.

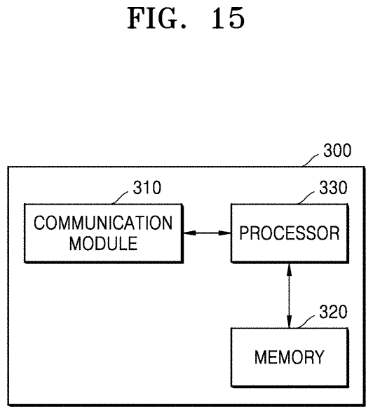

In the above description, according to an embodiment, operations S110 through 182 may be further divided into additional operations or may be combined into sub-operations. Also, some operations may be omitted when needed or the order between operations may also be changed. In addition, even though the following description of FIG. 15 is omitted, the description may also be applied to the method of automatically granting inspection authority to a worker on the basis of work results of a crowdsourcing-based project described with reference to FIGS. 1 through 14.

Hereinafter, an apparatus for automatically granting inspection authority to a worker on the basis of work results of a crowdsourcing-based project, according to an embodiment will be described with reference to FIG. 15.

FIG. 15 is a block diagram illustrating an apparatus for automatically granting inspection authority to a worker on the basis of work results of a crowdsourcing-based project, according to an embodiment.

Referring to FIG. 15, an apparatus 300 (hereinafter referred to as an apparatus) for automatically granting inspection authority to a worker on the basis of work results of a crowdsourcing-based project includes a communication module 310, a memory 320, and a processor 330.

The communication module 310 transmits crowdsourcing-based tasks of one project to a plurality of workers 32 to request to perform the tasks, and receives work results of the tasks from the plurality of workers 32. The communication module 310 transmits, to a plurality of inspectors 34, the work results received from the plurality of workers 32 to request to perform inspection, and receives inspection results from the plurality of inspectors 34. Here, the communication module 310 transmits, to the worker 32, rework corresponding to an inspection result input as a rejection to request to perform the rework, and receives the result of rework from the worker 32.

The memory 320 stores a program for automatically granting, on the basis of data received from the communication module 310, inspection authority to a worker on the basis of work results of a project.

The processor 330 executes the program stored in the memory 320. The processor 330 may perform the method of automatically granting inspection authority to a worker on the basis of work results of a crowdsourcing-based project described above with reference to FIGS. 3 through 14 by executing the program stored in the memory 320.

The apparatus 300 described above with reference to FIG. 15 may be provided as a component of the server described above.

A method of automatically granting inspection authority to a worker on the basis of work results of a crowdsourcing-based project, according to an embodiment, as described above may be implemented as a program to be combined with a computer that is hardware and to be executed, and then may be stored in a computer-readable recording medium.

In order for the computer to read the program and execute the methods implemented as the program, the above-described program may include a code coded in a computer language such as C, C++, JAVA, Ruby, and machine language that may be read by a processor (CPU) of the computer via a device interface of the computer. Such code may include functional code related to a function that defines functions needed for executing the above methods, and the like, and may include execution procedure-related control code needed for the processor of the computer to execute the functions according to a preset procedure. Also, such code may further include memory reference-related code indicating a location (address) in an internal or external memory of the computer at which additional information or media needed for the processor of the computer to execute the functions may be referred to. Also, when the processor of the computer needs to communicate with any other computer or server at a remote location to execute the functions, the code may further include communication-related code indicating a method of communicating with any other computer or server at a remote location by using a communication module of the computer, and information or media that is transmitted and/or received during communication, and the like.

The storage medium refers to a medium that stores data semi-permanently and may be read by a device, rather than a medium that stores data for a short moment, such as a register, a cache, or a memory. In detail, examples of the storage medium include ROM, RAM, CD-ROM, magnetic tape, floppy disks, optical data storage devices, and the like but are not limited thereto. In other words, the program may be stored in various types of recording media on various servers that may be accessed by the computer or in various types of recording media on the computer of a user. Also, the media may be distributed over network-coupled computer systems so that computer-readable code is stored in a distributed fashion.

The foregoing description of the disclosure is for purposes of illustration, and those of ordinary skill in the art to which the disclosure pertains may understand that it may be easily modified into other specific forms without changing the technical spirit or essential features of the disclosure. Therefore, it may be understood that the embodiments described above are illustrative in all respects and not restrictive. For example, each element described as a single type may be implemented in a distributed manner, and likewise, elements described as being distributed may also be implemented in a combined form.

The scope of the disclosure is defined by the following claims, rather than by the above description, and all changes or modifications derived from the concept and scope of the claims and equivalents thereof may be construed as being included in the scope of the disclosure.

What is claimed is:

1. A method of automatically granting inspection authority to a worker on the basis of work results of a crowdsourcing-based project (hereinafter, a project), performed by a computer, the method comprising:
assigning a plurality of tasks of the project to a plurality of workers and requesting to perform the tasks;
receiving a plurality of work results from the plurality of workers;
assigning the plurality of work results to a plurality of inspectors and requesting to perform inspection;
receiving, from the plurality of inspectors, a plurality of inspection results for the plurality of work results as inspection passes or rejections;
calculating a number of cases of consecutive inspection passes by counting a number of cases of inspection passes for each worker, on the basis of the inspection results;
extracting a worker having the number of cases of consecutive inspection passes matching a preset first value and selecting the extracted worker as a limited inspector; and
granting the limited inspector inspection authority to perform the tasks of the project and perform the inspection at the same time, wherein
the plurality of inspectors include the limited inspector,
the assigning the plurality of work results to the plurality of inspectors and requesting to perform the inspection includes
assigning the limited inspector work results of tasks corresponding to a number of inspectable tasks and requesting to perform inspection,
the granting the limited inspector the inspection authority to perform the tasks of the project and perform the inspection at the same time includes:
calculating the number of inspectable tasks by counting the number of cases of inspection passes of the limited inspector, on the basis of inspection results for work results of the limited inspector; and
granting the limited inspector inspection authority over work results of tasks corresponding to the number of inspectable tasks,
an inspector (hereinafter, an unlimited inspector) other than the limited inspector from among the plurality of inspectors is granted inspection authority that is not limited on the number of cases,
the limited inspector is granted inspection authority over work results of tasks corresponding to the number of inspectable tasks, and
the number of inspectable tasks increases according to a number of cases of inspection passes from among work results that are input by the limited inspector while performing the tasks of the project at the same time, after being selected as the limited inspector.

2. The method of claim 1, further comprising:
depriving the limited inspector of the inspection authority to perform the tasks of the project and perform the inspection at the same time, and canceling selection as the limited inspector of the project, wherein
the canceling the selection as the limited inspector includes:
counting the number of rejected cases of the limited inspector, on the basis of inspection results for work results of the limited inspector; and
depriving the inspection authority to perform the tasks of the project and perform the inspection at the same time, and canceling the selection as the limited inspector of the project, on the basis of the number of rejected cases of the limited inspector.

3. The method of claim 2, wherein the depriving the inspection authority and canceling the selection as the limited inspector includes maintaining the inspection authority of the limited inspector only for work results of tasks corresponding to the number of inspectable tasks calculated up to the present, and then depriving the inspection authority.

4. The method of claim 2, wherein the counting the number of rejected cases of the limited inspector includes counting the number of rejected cases of the limited inspector after being selected as the limited inspector.

5. The method of claim 2, wherein the selecting as the limited inspector includes, when the number of cases of consecutive inspection passes of the worker who is canceled from the selection as the limited inspector matches a preset first value, re-extracting the worker canceled from the selection and re-selecting the re-extracted worker as a limited inspector.

6. The method of claim 1, wherein the assigning the plurality of work results to the plurality of inspectors and requesting to perform the inspection includes assigning the limited inspector work results received from another worker except for work results received from the limited inspector and requesting to perform inspection.

7. The method of claim 1, further comprising,
when the inspection results are received as rejections, requesting a worker who performs work on rejected work results to perform rework, wherein
the work results include rework results that are the results of rework performed by the worker, and
the calculating the number of cases of consecutive inspection passes includes calculating the number of cases of consecutive inspection passes by counting the number of cases of inspection passes for each worker, on the basis of the inspection results including inspection results for the rework results.

8. The method of claim 1, wherein the calculating the number of cases of consecutive inspection passes includes calculating the number of cases of consecutive inspection passes by counting the number of cases of initial inspection passes for each worker, on the basis of the inspection results.

9. A non-transitory computer program stored in a computer-readable recording medium to be combined with a computer to execute a method of automatically granting inspection authority to a worker on the basis of work results of a crowdsourcing-based project, the computer program performing:
assigning a plurality of tasks of the project to a plurality of workers and requesting to perform the tasks;
receiving a plurality of work results from the plurality of workers;
assigning the plurality of work results to a plurality of inspectors and requesting to perform inspection;
receiving, from the plurality of inspectors, a plurality of inspection results for the plurality of work results as inspection passes or rejections;
calculating a number of cases of consecutive inspection passes by counting a number of cases of inspection passes for each worker, on the basis of the inspection results;
extracting a worker having the number of cases of consecutive inspection passes matching a preset first value and selecting the extracted worker as a limited inspector; and
granting the limited inspector inspection authority to perform the tasks of the project and perform the inspection at the same time, wherein
the plurality of inspectors include the limited inspector,
the assigning the plurality of work results to the plurality of inspectors and requesting to perform the inspection includes assigning the limited inspector work results of tasks corresponding to a number of inspectable tasks and requesting to perform inspection,
the granting the limited inspector the inspection authority to perform the tasks of the project and perform the inspection at the same time includes:
calculating the number of inspectable tasks by counting the number of cases of inspection passes of the limited inspector, on the basis of inspection results for work results of the limited inspector; and
granting the limited inspector inspection authority over work results of tasks corresponding to the number of inspectable tasks,
an inspector (hereinafter, an unlimited inspector) other than the limited inspector from among the plurality of inspectors is granted inspection authority that is not limited on the number of cases,
the limited inspector is granted inspection authority over work results of tasks corresponding to the number of inspectable tasks, and
the number of inspectable tasks increases according to a number of cases of inspection passes from among work results that are input by the limited inspector while performing the tasks of the project at the same time, after being selected as the limited inspector.
